(19) United States
(12) Patent Application Publication
(10) Pub. No.: US 2007/0011454 A1
(43) Pub. Date: Jan. 11, 2007

(54) METHOD FOR SAFELY DOWNLOADING SETTING DATA IN VoIP SYSTEM

(75) Inventors: CHIN-HUNG CHIEN, TU CHENG (TW); WEI-WEN CHUANG, TU CHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,637

(22) Filed: Apr. 15, 2006

(30) Foreign Application Priority Data
Jul. 9, 2005 (CN) 200510035909.1

(51) Int. Cl. H04L 9/00

(52) U.S. Cl. 713/168

(57) ABSTRACT

A method for safely downloading setting data in a Voice over Internet protocol (VoIP) system including a server, a VoIP device, and a console, includes steps of: establishing communication between the console and the VoIP device; determining whether a certificate authority of the VoIP device is valid; generating a session key randomly if the certificate authority of the VoIP device is valid; encrypting the setting data of the VoIP system employing the session key; encrypting the session key employing a public key; transmitting the encrypted data and the encrypted session key to the VoIP device; decrypting the encrypted session key employing a private key after the VoIP device received the encrypted data and the encrypted session key; decrypting the encrypted data to restore the setting data employing the session key; and checking whether the setting data are correct data.

### FIELD OF THE INVENTION

The present invention relates to a method for downloading data in a voice over Internet protocol (VoIP) system, and particularly to a method for safely downloading setting data in the VoIP system.

### DESCRIPTION OF RELATED ART

As the communications industry continues to dominate the growth of the global economy, providing a desired level of privacy for network users while also satisfying performance, flexibility, regulatory, and other requirements has become increasingly important. In particular, the advent of Internet protocol (IP) telephony has increased the requirements for information privacy to a marked degree.

However, encryption techniques used for transferring information streams between computers typically involve computationally intensive encipherment techniques that provide a much higher level of security than is typically needed for IP telephony. However, use of these techniques in an IP telephony environment may contravene the cryptography axiom that the encryptor is not tailored to particular security needs.

Other encryption techniques, although generally better adapted to requirements associated with IP telephony, use relatively simple linear and non-linear feedback shift registers to provide the output key sequences. Although such techniques provide reasonable levels of security and are typically less computationally intensive, they are often inflexible in their structure and with respect to the privacy provided. As a result of these and other deficiencies, current encryption techniques are inadequate to meet the requirements associated with IP telephony and other communications within communications networks.

### SUMMARY OF INVENTION

In an exemplary embodiment, a method for safely downloading setting data in a Voice over Internet protocol (VoIP) system including a server, a VoIP device, and a console is provided. The method includes steps of: establishing communication between the console and the VoIP device; determining whether a certificate authority of the VoIP device is valid; generating a session key randomly if the certificate authority of the VoIP device is valid; encrypting the setting data of the VoIP system employing the session key; encrypting the session key employing a public key; transmitting the encrypted data and the encrypted session key to the VoIP device; decrypting the encrypted session key employing a private key after the VoIP device received the encrypted data and the encrypted session key; decrypting the encrypted data to restore the setting data employing the session key; and checking whether the setting data are correct data.

Other advantages and novel features will be drawn from the following detailed description of embodiments with the attached drawings, in which:

### BRIEF DESCRIPTION OF DRAWINGS

FIG. 1 is a schematic diagram of a Voice over Internet Protocol (VoIP) system in accordance with an exemplary embodiment of the present invention;

FIG. 2 is a flow chart of an encryption process for safely downloading setting data in the VoIP system in accordance with another exemplary embodiment of the invention; and

FIG. 3 is a flow chart of a decryption process for securely downloading setting data in the VoIP system in accordance with a further exemplary embodiment of the present invention.

### DETAILED DESCRIPTION

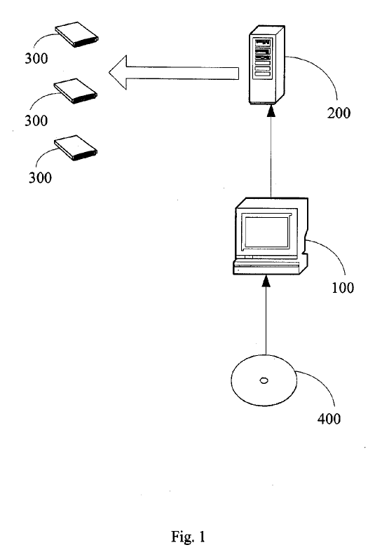

FIG. 1 is a schematic diagram of a Voice over Internet Protocol (VoIP) system in accordance with an exemplary embodiment of the present invention. In the embodiment, the VoIP system includes a console 100, a provision server 200, a plurality of VoIP devices 300, and a memory 400. In the embodiment, the VoIP devices 300 may be VoIP gateways, which are respectively connected to telephones (not shown). The memory 400 may be a CD-ROM, a hard disk, or other kind of storing device.

Certificates and keys of an asymmetric algorithm thereof are generated when the VoIP devices 300 are manufactured. Typically, the keys of the asymmetric algorithm includes a public key and a private key, the certificates includes a root certificate and a certificate authority. The private key and the certificate authority are pre-stored in the VoIP devices 300, the public key and the root certificate are pre-stored in the memory 400. The console 100 is used for encrypting setting data of the VoIP devices 300, and transmitting the encrypted data to the provision server 200. The VoIP devices 300 download the setting data from the provision server 200, and update settings thereof according to the setting data.

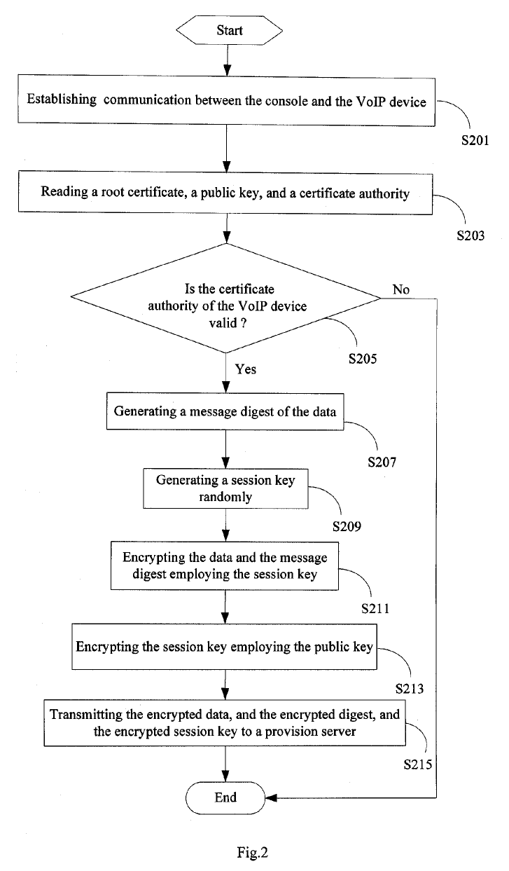

FIG. 2 is a flow chart of an encryption process for safely downloading setting data in the VoIP system in accordance with an exemplary embodiment of the invention.

The process begins in step S201, where communication between the console 100 and the VoIP device 300 is established.

In step S203, the console 100 reads the root certificate, the public key, and the certificate authority in the memory 400.

In step 205, the console 100 determines whether the certificate authority of the VoIP device 300 is valid. In the exemplary embodiment, the console 100 compares the root certificate with the certificate authority to determine whether the certificate authority is valid. If the certificate authority is valid, the console 100 communicates with the VoIP device 300.

In step S207, the console 100 generates a message digest of setting data of the VoIP device 300 according to a message-digest algorithm. The message digest is a unique serial number. In the exemplary embodiment, the console 100 uses a message-digest algorithm 5 (MD5) to generate the message digest.

In step S209, the console 100 generates a session key randomly. In the exemplary embodiment, since the session key is generated randomly, the session key is variable.

In step S211, the console 100 uses the session key to encrypt the setting data and the message digest according to a symmetric algorithm. It should be noted that since the session key is generated randomly, the console 100 may use different session keys each time.

In step 213, the console 100 uses the public key stored in the memory 400 to encrypt the session key according to the asymmetric algorithm.

In step S215, the console 100 inserts the encrypted session key and the encrypted message digest into the encrypted data, and transmits the encrypted data to the provision server 200.

It should be noted that in other embodiments, the encrypted data, the message digest, and the encrypted session key may be transmitted to the provision server 200 separately.

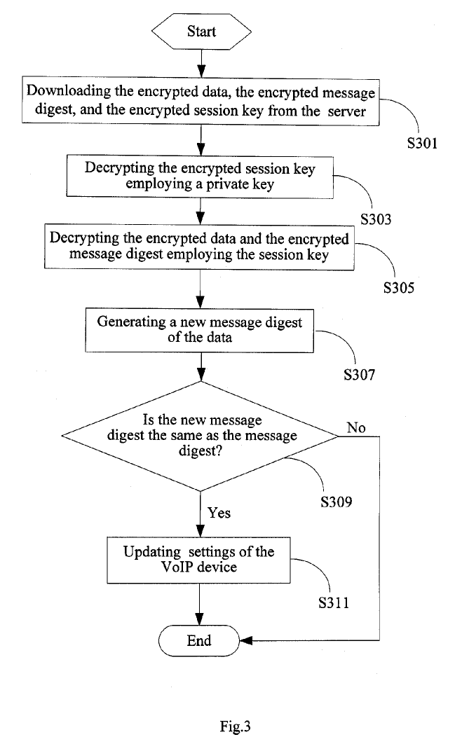

FIG. 3 is a flow chart of a decryption process of a method for securely downloading data in the VoIP system in accordance with anther exemplary embodiment of the present invention.

In step S301, the VoIP device 300 downloads the encrypted data, the encrypted message digest, and the encrypted session key from the provision server 200.

In step S303, the VoIP device 300 uses the private key pre-stored in the VoIP device 300 to decrypt and restore the encrypted session key.

In step 305, the VoIP device 300 uses the session key to decrypt the encrypted data and the encrypted message digest, and restore the data and the message digest.

In step S307, the VoIP device 300 calculates a new message digest of the data according to the message digest algorithm. In the exemplary embodiment, the VoIP device 300 uses the message-digest algorithm 5 to calculate the new message digest.

In step S309, the VoIP device 300 checks whether the new message digest is the same as the message digest. If the new message digest is the same as the message digest, the process proceeds to step S311 described below.

In step S311, the settings of the VoIP device 300 is updated according to the setting data.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A method for safely downloading setting data in a Voice over Internet protocol (VoIP) system comprising a server, a VoIP device, and a console, the method comprising steps of:
establishing communication between the console and the VoIP device;
determining whether a certificate authority of the VoIP device is valid;
generating a session key randomly if the certificate authority of the VoIP device is valid;
encrypting the setting data of the VoIP system employing the session key;
encrypting the session key employing a public key;
transmitting the encrypted data and the encrypted session key to the VoIP device;
decrypting the encrypted session key employing a private key after the VoIP device received the encrypted data and the encrypted session key;
decrypting the encrypted data to restore the setting data employing the session key; and
checking whether the setting data are correct data.

2. The method as recited in claim 1, wherein the step of determining whether the certificate authority of the VoIP device is valid further comprises a step of comparing a root certificate with the certificate authority.

3. The method as recited in claim 2, further comprising a step of storing the root certificate, the certificate authority, and the public key in the console before checking the certificate authority of the VoIP device.

4. The method as recited in claim 3, wherein the console comprises a memory, and the root certificate and the public key are pre-stored in the memory.

5. The method as recited in claim 1, wherein the certificate authority is pre-stored in the VoIP device.

6. The method as recited in the claim 1, further comprising steps of:
generating a message digest of the data employing a message digest algorithm;
encrypting the setting data and the message digest employing the session key according to a symmetric algorithm;
encrypting the session key employing the public key according to an asymmetric algorithm; and
transmitting the encrypted data, the encrypted message digest, and the encrypted session key to the server.

7. The method as recited in the claim 6, further comprising steps of:
downloading the encrypted data, the encrypted message digest, and the encrypted session key from the server;
decrypting the encrypted session key employing a private key to restore the session key according to the asymmetric algorithm;
decrypting the encrypted data and the encrypted message digest employing the session key to restore the data and the message digest;
generating a new message digest employing the message digest algorithm;
determining whether the new message digest is the same as the message digest; and
updating the settings of the VoIP device according to the data if the new message digest is the same as the message digest.

8. The method as recited in claim 7, wherein the private key is pre-stored in the VoIP device.

9. The method as recited in claim 6, wherein the message digest algorithm is message digest algorithm 5 (MD5).
